(19) United States
(12) Patent Application Publication
(10) Pub. No.: US 2005/0177541 A1
(43) Pub. Date: Aug. 11, 2005

(54) Method and system for dynamically updating a process library

(75) Inventors: M. Bradley Wright, Draper, UT (US); Brady A. Sines, Draper, UT (US); James P. Gamache, Seattle, WA (US)

Correspondence Address: Lloyd W. Sadler;Parsons Behle & Latimer, Suite 1800, 201 South Main Street, Salt Lake City, UT, 84111, US

(73) Assignee: Zorch, Inc., Sandy, UT (US)

(21) Appl. No.: 10/773,055

(22) Filed: Feb. 4, 2004

(51) Int. Cl. G06F 7/00

(52) U.S. Cl. 707/1

(57) ABSTRACT

A system and method which allows users to track and manage the information gathered during the life of a project. The invention uses a novel method and system for tracking changes to processes within a project. A statistical analysis is done on the changes and the statistical information is merged with the existing process information to create a new version of the process. The information is then stored in a process library. As the new processes are used, the information stored is more accurate based on the previous analysis.

### BACKGROUND OF INVENTION

1. Field of the Invention

This invention relates to database systems. More specifically this invention relates dynamically changing a process in a database.

2. Description of Related Art

A variety of schemes have been used to create templates for projects such as project tracking systems etc. Templates are used to create a base from which a project is built. The templates are typically static and cannot be changed or developed based on information that is learned through the life of the project. Because of the inflexibility of templates, statistics such as times, values, dates, and other information which is gathered during the life of a process or project cannot be easily reintegrated back into the original template to create a new template for use in a second project. Typically, with the current state of technology, any changes such as those just mentioned must be manually updated in the template. Although these references may not constitute prior art, for general background material, the reader is directed to the following United States Patent documents, each of which is hereby incorporated by reference in its entirety for the material contained therein: U.S. Patent and Patent Application Numbers: U.S. Pat. Nos. 6,513,008, 6,480,863, 6,213,530, 6,182,279, 6,085,201, 6,077,085, 5,907,844, 5,900,870, 5,819,283, 2003/0065681, 2003/0090526, 2002/0194059, 2002/0152254.

### SUMMARY OF INVENTION

It is desirable to provide a system and method for creating, maintaining and dynamically updating a process library.

Therefore it is the general object of an embodiment of this invention to provide a system and method for creating and a process library by getting one or more processes from a process library and assigning a process type to the process and assigning tasks to the process.

It is a further object of an embodiment of this invention to provide a system and method for creating a process library where the process library is stored in a database.

It is a further object of an embodiment of this invention to provide a system and method for creating a process library where the process library is stored in a database that can be, but is not limited to a relational database, an object database, a directory service, a file system, an XML structure, a web-service and a SQL database.

It is a further object of an embodiment of this invention to provide a system and method for creating a process library where values are assigned to tasks based on a best guess analysis.

It is a further object of an embodiment of this invention to provide a system and method for creating a process library where values are assigned to tasks based on input from one or more users.

It is a further object of an embodiment of this invention to provide a system and method for creating a process library where one or more processes are created programmatically.

It is a further object of an embodiment of this invention to provide a system and method for creating a process library where a process library resides on a network.

It is a further object of an embodiment of this invention to provide a system and method for creating a process library where one or more processes are combined to create a compound process.

It is a general object of an embodiment of this invention to provide a system and method for creating a project that uses a process from a process library.

It is a further object of an embodiment of this invention to provide a system and method for creating a project that uses a process from a process library where one or more projects are combined to crate a compound project.

It is a general object of an embodiment of this invention to provide a system and method for dynamically updating one or more processes in a process library.

It is a further object of an embodiment of this invention to provide a system and method for dynamically updating one or more processes in a process library where the process can be updated by statistical analysis which can be, but is not limited to regression, re-averaging, chi-square, T-test, log transformation, smoothing, efficiency, min/max, median and/or mode.

It is a further object of an embodiment of this invention to provide a system and method for dynamically updating one or more processes in a process library where changes to a process are determined on a condition which can be, but is not limited to a periodic update, a user requested update, and/or an end of project update.

These and other objects of this invention will be readily apparent to those of ordinary skill in the art upon review of the following drawings, detailed description and claims. In the preferred embodiment of this invention, the system and method use a novel process library which allows information which is learned through the life of a project to be statistically analyzed. The analyzed information is then reintegrated into a newer version of the process in a process library which allows later projects to take advantage of the learned information.

### BRIEF DESCRIPTION OF DRAWINGS

In order to show the manner that the above recited and other advantages and objects of the invention are obtained, a more particular description of the preferred embodiments of this invention, which is illustrated in the appended drawings, is described as follows. The reader should understand that the drawings depict only present preferred and best mode embodiments of the invention, and are not to be considered as limiting in scope. A brief description of the drawings is as follows:

FIG. 1 is a block diagram of the present preferred process library system.

FIG. 2 is a block diagram of the present preferred process library system implemented on a network.

FIG. 3 is a flow diagram of the present preferred method for creating a process in a process library.

FIG. 4 is a flow diagram of the present preferred method for creating a project that uses a process from a process library.

FIG. 5 is a flow diagram of the present preferred method for creating a new version of a master process based on statistical analysis of process usage data.

FIG. 6 is a flow diagram of the present preferred method for statistically analyzing elements of a process to create a new version of a master process.

FIG. 7 is a block diagram of the present preferred hierarchy of how a project or nested project is derived.

FIG. 8 is a block diagram of the present preferred life cycle process for a master process.

FIG. 9 is a block diagram of the present preferred process of automatic learning to create a new version of a master process.

FIG. 10 is a flow diagram of the present preferred process for creating a nested project.

Reference will now be made in detail to the present preferred embodiment of the invention, examples of which are illustrated in the accompanying drawings.

### DETAILED DESCRIPTION

Definitions

Task: A step or action, or a series of steps or actions taken to accomplish an objective, function, or assignment. A task is the smallest unit of work within a process or project. A task can be, but is not limited to an event, a milestone, a deliverable, a resource, a cost, and the like.

Event: A meeting, activity, occurrence, or happening.

Milestone: A planned reference point or measurement. A milestone is an important advancement, turning point, decision point or achievement.

Deliverable: The outcome of a task, process or project, or the accomplishment of an objective.

Resources: The supplies or manpower needed to accomplish a task or deliverable.

Process: A series of one or more tasks, events, deliverables and resources organized into a defined group to achieve a desired result or accomplish a task or deliverable.

Master Process: The process stored in the process library.

Compound Process: A process that contains more than one other process. Compound processes facilitate the assembly of a project.

Project: A plan that contains a process or series of processes, or compound process or processes, assembled in serial and/or parallel to achieve a goal or objective over time.

Nested Project: Similar to a compound process, a nested project is a project that contains more than one other project.

Checklist: A checklist is a series of user-defined tasks that are created at any time within a process or project. It typically results from the sub-division of a task or other assignment resulting in a list of new tasks, events or deliverables. A checklist can be incorporated into a master process during the automated learning process or manually.

Where-Used: A mechanism to track where a process or compound process is used relative to other processes, compound processes, projects, or nested projects. This allows the system to provided additional project metrics.

Process Type: An identifier used to differentiate every process, revision, or permutation.

Process Usage Data: The discrete and cumulative data collected about the actual use and performance of tasks, events and deliverables within a process. This data includes, but is not limited to, actual time, actual costs, and the actual resources required, both human and non-human, and the storage of planned estimates in these categories.

Process Data: The discrete and cumulative data collected while the process is in use. This includes but is not limited to, information about how many times the process was used within a particular project, or how many times it should have been used. The process meta-data that is collected is based on parameters that are user defined, either at “run-time” or defined in advance as a static template or master process.

Life Cycle: The course of developmental changes for checklists, processes, projects, master processes, or other data sets. A series of differing stages of progression, typically Draft, Released, and Obsolete. Versioning or revision control is integral to the lifecycle management process.

Statistical Analysis: The automatic process for evaluating various data sets related to process usage, performance and permutations. The statistical methods and analysis include, but are not limited to regression, re-averaging, chi-square, T-test, log transformation, smoothing, efficiency, min/max, median, and mode.

Best Guess Analysis: The process of estimating or assuming the requirements or outcome, at any level or degree, of a task, process, project, resource, event, deliverable or milestone, or any combination thereof.

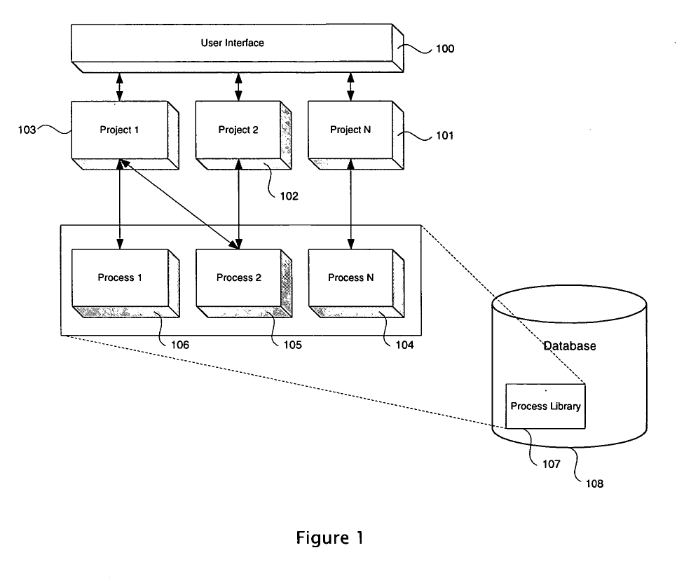

FIG. 1 is a block diagram of the present preferred process library system. A user interface 100 is used to modify and/or update data in a project 101, 102, 103. Input data can be received in other ways such as programmatically and the like. A project 101, 102, 103 is created by creating instances of processes 104, 105, 106 from the process library. A process 104, 105, 106, is a grouping of events which are then used to constitute a project. For example, a project can be the steps (processes) necessary to get a drug approved through the Food and Drug Administration. Other examples can be, but are not limited to software/hardware development, manufacturing, business, inventory/operation, medical practice/dental, legal procedures, construction, and the like. A project 101, 102, 103, can contain one or more processes 104, 105, 106. Processes 104, 105, 106, are components that make up a project.

Examples of process can be, but are not limited to, tracking the administration of a drug by in a specific trial, administration of a drug by a specific doctor over the life of a project, development of a specific component of a software, hardware, manufacturing, or tracking a single or group of patent documents in a law firm, or any other industry or desired result that requires a series of steps to accomplish and the like. A project 101, 102, 103 is created using one or more processes 104, 105, 106. FIG. 1 shows project one 103 which uses process one 106 and process two 105. Project two 102 uses process two 105 and project N 101 uses process N 104. The processes 104, 105, 106 are stored in a process library 107 which is in a database 108. The database 108 can be, but is not limited to a relational database, a directory service, an SQL database, an object database, a file system, XML structures, web-services and the like.

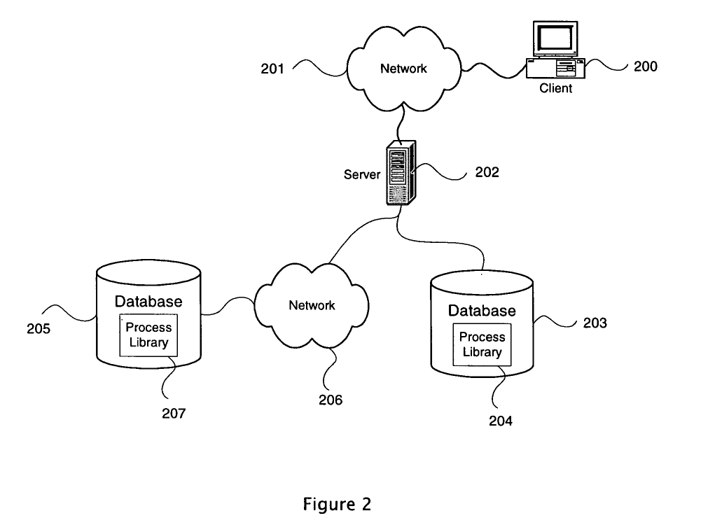

FIG. 2 is a block diagram of the present preferred process library system implemented on a network. Access to the process library system occurs from a client 200 which accesses a server 202 over a network 201. The client 200 can access a project 101, 102, 103 on a server 202 from user interface 100. The user interface 100 can be, but is not limited to a web server, a cell phone, a Personal Digital Assistant (PDA), a mobile device, a computing device, an application program and the like. The application can run over, but are not limited to the Internet, a Local Area Network (LAN), a Wide Area Network (WAN), a wireless Network and the like. The server 202 communicates to a database 203, 205 which each contain all and/or part of the process library 204, 207. Processes 104, 105, 106 are stored the process library 204, 207. The server 202 is communicates with the database 203 regardless of the database's location. The second database 207 is connected to the server 202 over a second network 606 or the database 207 can be connected over the first network 201.

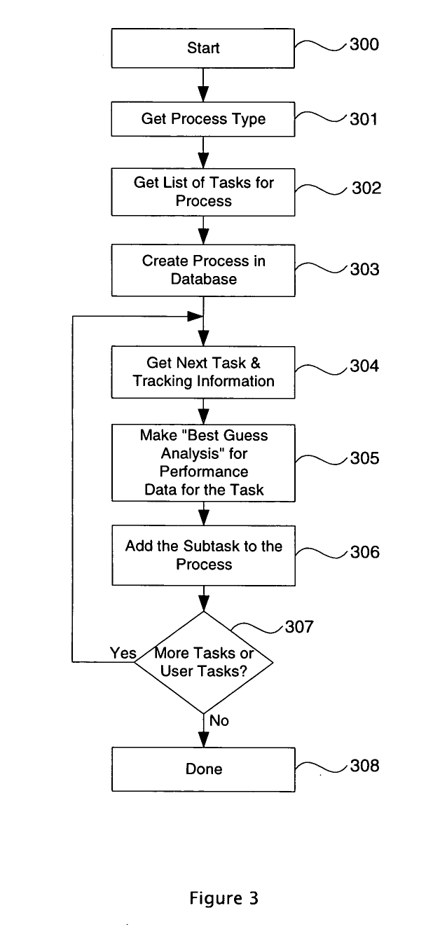

FIG. 3 is a flow diagram of the present preferred method for creating a process in a process library. The method starts 300 by getting 301 the process type. The process type is used to track unique processes. The process type is a unique identifier for the process. The method gets 302 a list of tasks for the process which are used in creating a process.

The tasks come from a checklist that is generated by the user that can come from a variety of sources. Tasks are all of the parts of a process such as review period, an audit time, or specific things that must be accomplished or tracked and the like. Tasks can have associated items such as resources, people, goods, services, durations, any user defined data and the like. A process is created 303 in a process library 107 which is in a database 108. The method gets 304 the next task along with the task's tracking information. The tracking information for the task can be, but is not limited to dates, type, cost, amounts, time, and the like. The method makes 305 a “best guess analysis” for performance data for the task and the data is stored with the task or as part of the process. Performance data for example, can be but is not limited to, projected time, projected resources, projected costs and the like. The task is added 306 and saved with the process which was created in step 303. The method checks 307 to see if there are any more tasks. A user can also add additional tasks if necessary in check 307. If there are more tasks to be added in test 307, the method gets 304 the next task. Otherwise, if test 307 is no, the method is done 308.

Although these steps are preformed in the designated order in the present embodiments, in alternative envisioned embodiments of this invention, the ordering of the steps can be varied significantly without departing from the concept of this invention.

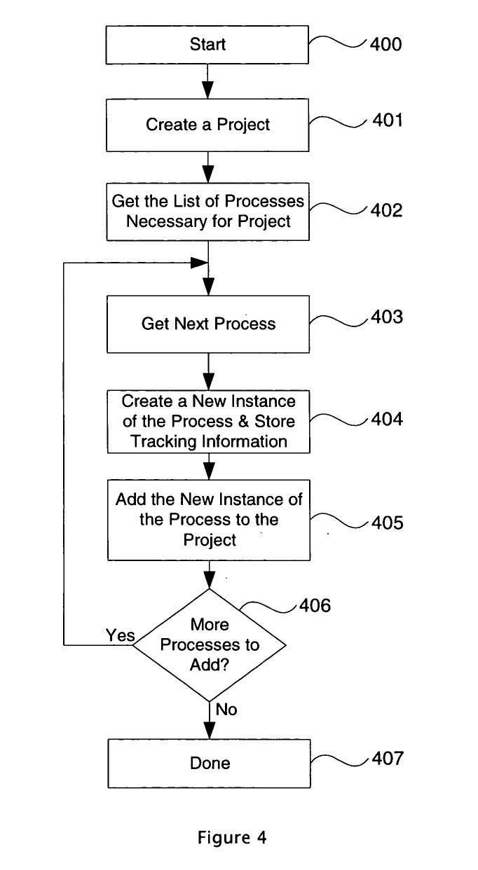

FIG. 4 is a flow diagram of the present preferred method for creating a project that uses a process from a process library. The method begins 400 by creating 401 a project 101, 102, 103. The project 101, 102, 103 can be created from the user interface 100, and/or programmatically, and/or by the user cutting and pasting into the project and the like. The method gets 402 a list of processes 104, 105, 106 which are necessary for the project 101, 102, 103. The method gets 403 the next process 104, 105, 106, from the list. A new instance of the process 104, 105, 106, is created 404 and the tracking information is stored. Examples of the tracking information can be, but are not limited to starting date, starting cost, number of resources, and the like. The new instance of the process 104, 105, 106, is added 405 to the project 101, 102, 103. The method checks 406 to see if there are more processes 104, 105, 106, to add to the project 101, 102, 103. If there are more processes 104, 105, 106, to add in test 406, the method gets 403 the next process 104, 105, 106. Otherwise, if test 406 is no, the method is done 407.

Although these steps are preformed in the designated order in the present embodiments, in alternative envisioned embodiments of this invention, the ordering of the steps can be varied significantly without departing from the concept of this invention.

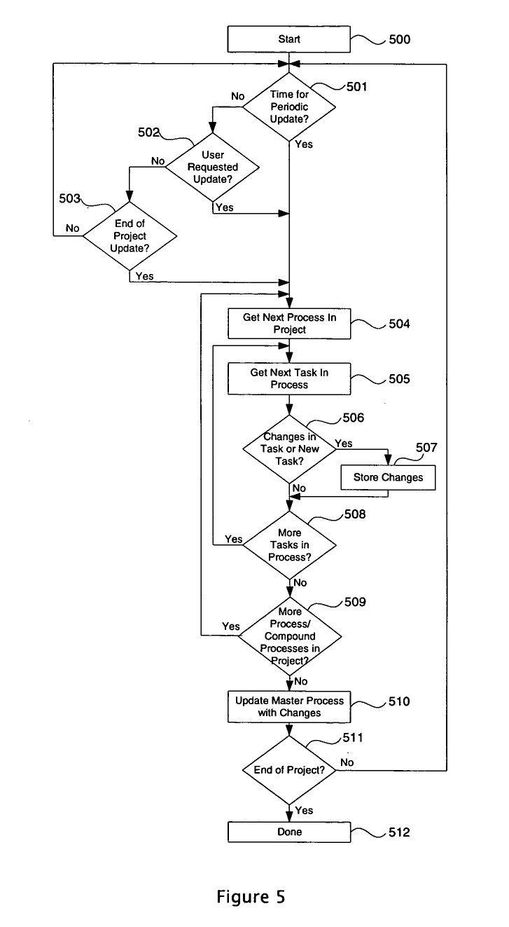

FIG. 5 is a flow diagram of the present preferred method for creating a new version of a master process based on statistical analysis of process data. The method begins 500 by checking 501 to see if it is time for a periodic update. If it is not time for a periodic update in test 501, the method checks 502 to see if the user has requested an update. If the user has not requested an update in test 502, the method checks 503 to see if the project 101, 102, 103, has completed. If the project 101, 102, 103, has not completed in test 503, the process checks 501 to see if it is time for a periodic update. Otherwise, if any of tests 501, 502, or 503 were yes, the method gets 504 the next process 104, 105, 106 in the project 101, 102, 103. The method gets 505 the next task in the process 104, 105, 106. The method checks 506 to see if any changes were made in the task or if a new task was added to the project. If there were changes or a new task in test 506, the method stores 507 the changes and checks 508 for more tasks in the process 104, 105, 106. Otherwise, the method checks 508 for more tasks in the process 104, 105, 106. If there are more tasks in test 508, the method gets 505 the next task in the process 104, 105, 106.

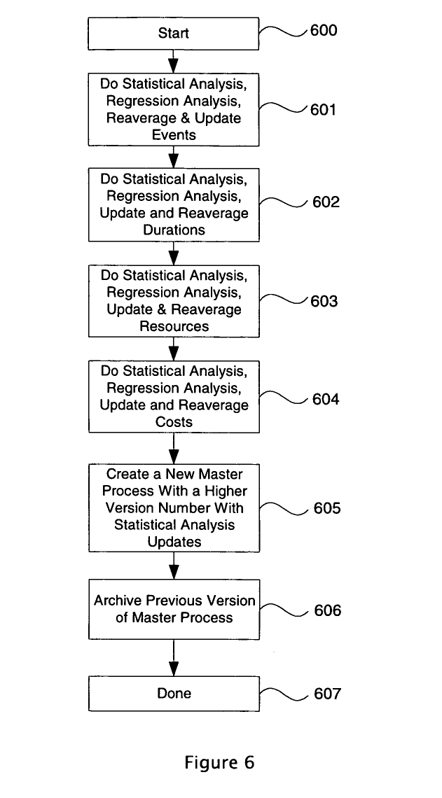

Otherwise, if test 508 is no, the method checks 509 to see if there are more processes 104, 105, 106 in the project 101, 102, 103. Check 509 also includes checking for each process in a compound process and getting each process from the compound process. If there are more processes 104, 105, 106 in the project 101, 102, 103, in test 509, the method gets 504 the next process 104, 105, 106 in the project 101, 102, 103. Otherwise, if test 509 is no, the method updates 510 the master process with the changes gathered in step 507. FIG. 6 describes in greater detail how the master process is updated in step 510. The method checks 511 to see if the project 101, 102, 103 is done. If the project is not finished in test 511, the method checks 501 to see if it is time for a periodic update. Otherwise, if test 511 is yes, the method is done 512.

Although these steps are preformed in the designated order in the present embodiments, in alternative envisioned embodiments of this invention, the ordering of the steps can be varied significantly without departing from the concept of this invention.

FIG. 6 is a flow diagram of the present preferred method for statistically analyzing elements of a process to create a new version of a master process and the master process. The process starts 600 by doing 601 a statistical analysis, a regression analysis, and re-averaging the process events. Information from the previous instance of the process is stored so that averages and the like can be weighted over time. A statistical analysis, regression analysis, and re-averaging of the durations is done 602. A statistical analysis, which can include regression analysis and re-averaging of the resources, is done 603. A statistical analysis, regression analysis, and re-averaging of the costs is done 604. A new master process is created 605 with a higher (or different) version number is created with the new information created in steps 601-604. The previous version of the master process is archived 606 and saved off. This way both the new and previous versions of the master process can be used. The life cycle of the process also includes other modes such as draft. A new version may have to be approved before the draft is allowed to be the current master process.

In alternative embodiments the calculations and types of statistical analysis may be varied without departing from the concept of this invention. Although these steps are preformed in the designated order in the present embodiments, in alternative envisioned embodiments of this invention, the ordering of the steps can be varied significantly without departing from the concept of this invention.

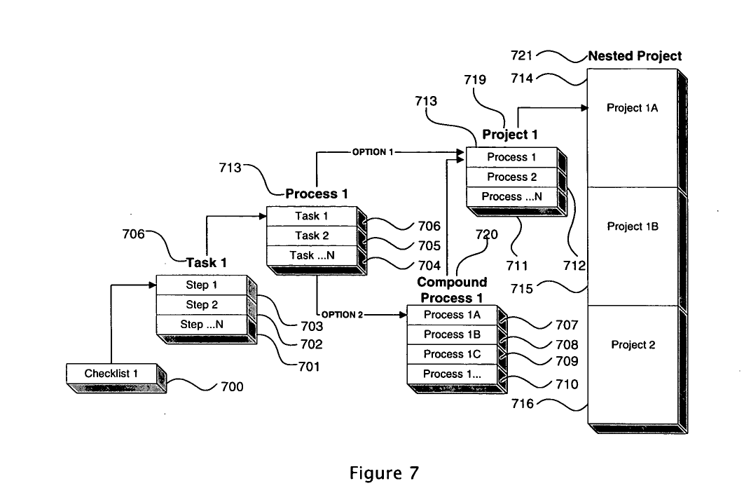

FIG. 7 is a block diagram of the present preferred hierarchy of how a project 719, 714, 715, 716 or a nested project 221 is derived. A checklist 700 of user defined tasks is used to select one or more tasks 706 which are a series of one or more steps 701-703. Tasks 704, 705, 706 are used to create a process 711, 712, 713. One or more processes 711, 712, 713 are used to create a project 719, 714, 715, 716. In addition to, and/or a project can also be made up of a compound process 720 which is has multiple processes 707, 708, 709, 710 within the compound process 720. A nested project 721 is made up of more than one project 714, 715, 716.

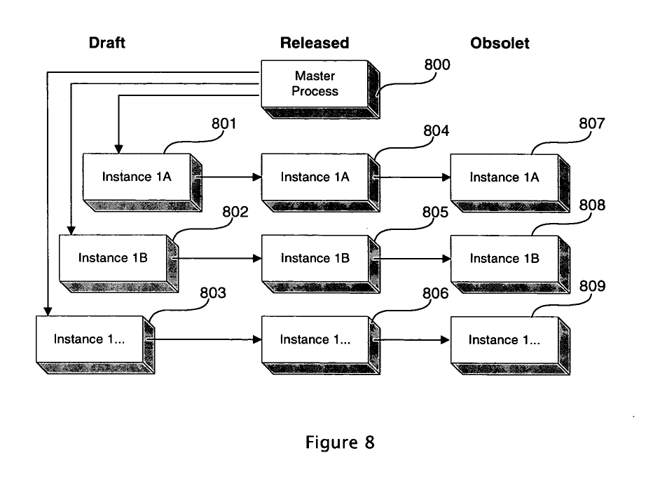

FIG. 8 is a block diagram of the present preferred life cycle process for a master process 800. As projects need to use the master process 800, a new instance 801, 802, 803 of the master process 800 is created. The new instance 801, 802, 803 is used within the project. Initially when the instance 801, 802, 803 of the master process 800 is created it is created in a draft state. The instance 801, 802, 803 are then released in the project into a released state 804, 805, 805. When the instance 804, 805, 806 is in the released state, the instance of the process 804, 805, 806 can now be used in the project. Later, when the project is complete, the released instance is then moved to an obsolete state 807, 808, 809. The data within the processes 804, 805, 806 is analyzed statistically to create a new version of the master process 800. The obsolete versions of the instances 807, 808, 809 are then archived so they can be retrieved if necessary.

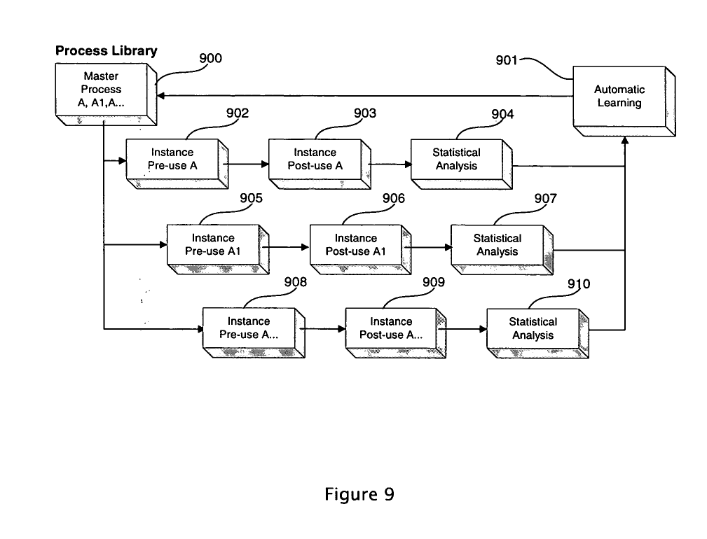

FIG. 9 is a block diagram of the present preferred process of automatic learning 901 to create a new version of a master process 900. A master process 900 is used to create pre-use instances 902, 905, 908 of the master process 900 for use within a project. Once the pre-use instances 902, 905, 908 of the process are used within the project and the project is complete, the post-use instances 903, 906, 909 are then statistically analyzed 904, 907, 910. After the statistical analysis 904, 907, 910 the new data from the analysis is integrated into an automatic learning system 901 which then creates a new version of the master template 900 which contains new information based on the data analyzed in blocks 904, 907, 910. This process can be repeated multiple times.

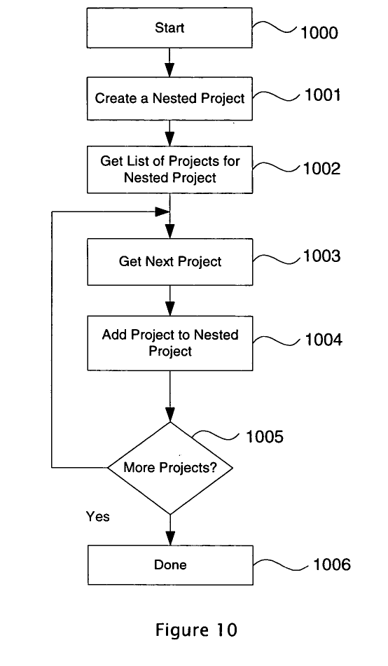

FIG. 10 is a flow diagram of the present preferred process for creating a nested project. The process starts 1000 when a request to create 1001 a nested project is generated. A list of projects for the nested project 1002 is created. An example of how this is done can but is not limited to a pop-up window where the user selects the projects. The process gets 1003 the next project and the projects associated information. The project is then added 1004 to the nested project. Test 1005 checks to see if there are any more projects. If so, the process gets 1003 the next project to add to the nested project. Otherwise, the process is done 1006.

Although these steps are performed in the designated order in the present embodiments, in alternative envisioned embodiments of this invention, the ordering of the steps can be varied significantly without departing from the concept of this invention.

In addition, all the previously describes process library methods and systems can be implemented using a variety of processes, but are not limited to computer hardware, microcode, firmware, software, and the like.

The described embodiments of this invention are to be considered in all respects only as illustrative and not as restrictive. Although specific flow diagrams and block diagrams are provided, the invention is not limited thereto. The scope of this invention is, therefore, indicated by the claims rather than the foregoing description. All changes, which come within the meaning and range of equivalency of the claims, are to be embraced within their scope.

1. A method for creating a process library comprising:
A. getting a process type;
B. creating one or more processes in a process library and assigning said process type to said one or more processes;
C. getting one or more tasks for said process;
D. assigning values to said one or more tasks; and
E. attaching said one or more tasks to said one or more processes.

2. A method for creating a process library as recited in claim 1, wherein said process library is stored in a database.

3. A method for creating a process library as recited in claim 2 wherein said database is a database selected from the group consisting of a relational database, an object database, a directory service, a file system, an XML structure, a web-service and an SQL database.

4. A method for creating a process library as recited in claim 1 wherein assigning values to said one or more tasks is based on a best guess analysis.

5. A method for creating a process library as recited in claim 1 wherein assigning values to said one or more tasks is based on one or more users input.

6. A method for creating a process library as recited in claim 1 wherein said one or more processes are created programmatically.

7. A method for creating a process library as recited in claim 1 wherein said process library resides on a network.

8. A method for creating a process library as recited in claim 1 wherein said one or more processes are combined to create a compound process.

9. A method for creating a project which uses a process from a process library comprising:
A. creating a project;
B. getting a list of one or more process from a process library;
C. creating an instance of said one or more process; and
D. adding said one or more processes to said project.

10. A method for creating a project which uses a process from a process library as recited in claim 9 wherein said project is combined with one or more second projects to create a compound project.

11. A method for dynamically updating a process in a process library comprising:
A. determining changes made to a process;
B. running a statistical analysis on said changes;
C. creating statistical information by taking information from said process and information from said statistical analysis;
D. creating a new version of said process using said statistical information.

12. A method for dynamically updating a process in a process library as recited in claim 11, wherein said statistical analysis is a statistical analysis selected from the group consisting of a regression, re-averaging, chi-square, T-test, log transformation, smoothing, efficiency, min/max, median, and mode.

13. A method for dynamically updating a process in a process library as recited in claim 11, where determining changes is based on a condition selected from the group consisting of a periodic update, a user requested update, and an end of project update.

14. A system for dynamically updating processes in a process library comprising:
A. a project;
B. one or more processes stored in a process library;
C. wherein said project is created using said one or more processes;
D. wherein changes are made in said one or more process; and
E. wherein a new version of said process is created by doing a statistical analysis of changes to said one or more processes and existing data in said process and wherein said new version of said one or more processes is updated with information from said statistical analysis.

15. A system for dynamically updating processes in a process library as recited in claim 14, wherein said process library is stored a database.

16. A system for dynamically updating processes in a process library as recited in claim 15 wherein said database is a database selected from the group consisting of a relational database, an object database, a directory service, a file system, an XML structure, a web-service and an SQL database.

17. A system for dynamically updating processes in a process library as recited in claim 14 wherein said one or more processes are created programmatically.

18. A system for dynamically updating processes in a process library as recited in claim 14 wherein said process library resides on a network.

19. A system for dynamically updating processes in a process library as recited in claim 14 wherein said one or more processes are combined to create a compound process.

20. A system for dynamically updating processes in a process library as recited in claim 14 wherein said one or more processes are created from one or more tasks.

21. A system for dynamically updating processes in a process library as recited in claim 20 wherein assigning values to said one or more tasks is based on a best guess analysis.

22. A system for dynamically updating processes in a process library as recited in claim 20 wherein assigning values to said one or more tasks is based one or more users input.

23. A system for creating a project which uses a process library comprising:
A. a project;
B. one or more process in a process library;
C. wherein an instance of said one or more process are created in said process library; and
D. wherein said one or more processes are added to said project.

24. A system for creating a process library as recited in claim 23 wherein said project is combined with one or more second projects to create a compound project.

25. A system for dynamically updating processes in a process library comprising:
A. one or more processes;
B. a process library which further comprises said one or more processes;
C. wherein a statistical analysis is made on said one or more processes based on changes to said one or more processes; and
D. wherein a new version of said one or more processes is created based on said statistical analysis.

26. A system for dynamically updating processes in a process library as recited in claim 25, wherein said statistical analysis is a statistical analysis selected from the group consisting of a regression, re-averaging, chi-square, T-test, log transformation, smoothing, efficiency, min/max, median, and mode.

27. A system for dynamically updating processes in a process library as recited in claim 25, where determining changes is based on a condition selected from the group consisting of a periodic update, a user requested update, and an end of project update.
